(19) United States
(12) Patent Application Publication
(10) Pub. No.: US 2008/0186335 A1
(43) Pub. Date: Aug. 7, 2008

(54) DISPLAY DRIVER IC HAVING EMBEDDED DRAM

(75) Inventor: Hiroyuki TAKAHASHI, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/971,926

(22) Filed: Jan. 10, 2008

(30) Foreign Application Priority Data
Feb. 6, 2007 (JP) 2007-026432

(51) Int. Cl. G09G 5/10

(52) U.S. Cl. 345/690

(57) ABSTRACT

A display driver IC for controlling display of an image on a display panel is provided with a DRAM and a driver circuit. The DRAM has a plurality of memory cells and stores digital data corresponding to the image. The driver circuit converts the digital data into a gray-scale voltage and outputs the gray-scale voltage to the display panel. The DRAM is configured to store one bit data by using n memory cells of the plurality of memory cells, n being an integer of 2 or more.

### INCORPORATION BY REFERENCE

This application is based upon and claims the benefit of priority from Japanese patent application No. 2007-026432, filed on Feb. 6, 2007, the disclosure of which is incorporated herein in its entirely by reference.

### BACKGROUND OF THE INVENTION

1. Field of the Invention

The present invention relates to a display driver IC (Integrated Circuit) for controlling display of an image on a display panel. In particular, the present invention relates to a display driver IC having an embedded DRAM (Dynamic Random Access Memory).

2. Description of Related Art

A liquid crystal display (LCD) is known as a kind of image display apparatuses. The liquid crystal display is provided with an LCD panel on which an image is displayed and an LCD driver IC that is an IC chip for controlling the image display. The LCD driver IC converts digital data (display data) corresponding to the image into gray-scale voltages, and applies the gray-scale voltages to pixels of the LCD panel. As a result, the image is displayed on the LCD panel.

In general, an SRAM (Static RAM) is used as a memory for storing the display data. The SRAM may be provided separately from the LCD driver IC or may be provided within the LCD driver IC. In the case where the SRAM is provided within the LCD driver IC, the SRAM is specifically called an “embedded SRAM (eSRAM)”.

Japanese Laid-Open Patent Application No. JP-P2002-56668 discloses an LCD driver IC in which the embedded SRAM is replaced with an embedded DRAM (eDRAM). A memory cell of a DRAM is smaller than a memory cell of an SRAM. Therefore, it is considered possible to reduce a chip area of the LCD driver IC by replacing the embedded SRAM with the embedded DRAM.

Japanese Laid-Open Patent Application No. JP-P2006-18002 discloses a display controller for supplying image data to a display driver that drives a display panel. The display controller has a DRAM dedicated to a sequential access operation and an SRAM dedicated to a random access operation.

The inventor of the present application has recognized the following points.

FIG. 1 illustrates a typical layout of a display driver IC 1 for controlling display of an image on a display panel 100. The display driver IC 1 is provided with an embedded DRAM 10 for storing display data, a power supply circuit 20, a driver circuit 30, a display control circuit 40 and the like. The display driver IC 1 is integrated on a single chip. As shown in FIG. 1, the display driver IC chip is long from side to side, i.e., the display driver IC chip has a “strip shape”. Such a strip shape is peculiar to the display driver IC used in an image display apparatus.

Such the IC chip having the strip shape is susceptible to stress during heat treatment and the like in a packaging process or a mounting process. When the embedded DRAM 10 in the IC chip is stressed, a data retention characteristic of a memory cell thereof can be varied. In the worst case, a data retention time becomes shorter than a design value, which causes malfunction of the display driver IC 1. That is to say, even if a proper IC chip is obtained at a chip manufacturing stage, an end product may become malfunctioning depending on the subsequent variation of the data retention characteristic.

### SUMMARY

In one embodiment of the present invention, a display driver IC having an embedded DRAM is provided. That is to say, the display driver IC according to the one embodiment is provided with a built-in DRAM in which digital data corresponding to a display image is stored. The embedded DRAM has a plurality of memory cells. The display driver IC is further provided with a driver circuit that converts the digital data into a gray-scale voltage and outputs the gray-scale voltage to a display panel.

The embedded DRAM according to the one embodiment performs data reading/writing by using n memory cells (n is an integer of 2 or more) of the plurality of memory cells as an “access unit”. In other words, the embedded DRAM stores one bit data by using the n memory cells.

For example, let us consider a case where n=2 and each access unit of the data reading/writing is composed of two memory cells (a first memory cell and a second memory cell). For example, the two memory cells are respectively connected to a pair of complementary bit lines (a first bit line and a second bit line) that are connected to the same sense amplifier. When the data “H” is written into a selected access unit, word lines connected to the two memory cells belonging to the access unit are selected at the same time, and the data “H” is then written into the first memory cell, while the complementary data “L” is written into the second memory cell. In a read operation from the access unit, the complementary bit lines are pre-charged to an intermediate potential, and then the word lines connected to the two memory cells are selected at the same time. As a result, a first potential corresponding to the data “H” appears on the first bit line, while a second potential corresponding to the data “L” appears on the second bit line. The sense amplifier senses the data stored in the access unit on the basis of a difference between the first potential and the second potential.

By way of comparison, let us consider a case where data reading/writing is performed with respect to one memory cell as usual. When one memory cell into which the data “H” is written is selected, the first potential corresponding to the data “H” appears on a bit line connected to the selected memory cell. The sense amplifier senses the data stored in the selected memory cell on the basis of a difference between the first potential and the intermediate potential. However, the first potential is decreased as electric charges are leaked from the cell capacitor of the selected memory cell, and the sensing performance of the sense amplifier is degraded. In the worst case, the first potential becomes lower than the intermediate potential and thus the sense amplifier erroneously identifies the data stored in the selected memory cell as the opposite data “L”.

According to the one example of the present invention, on the other hand, the data stored in the selected access unit is identified on the basis of the difference between the first potential, which is originally higher than the intermediate potential, and the second potential, which is lower than the intermediate potential, as described above. In other words, the data read margin is enlarged as compared with the usual DRAM. Although the first potential may be decreased due to the leakage of electric charges from the cell capacitor, the difference between the first potential and the second potential is still sufficient and thus the sensing performance of the sense amplifier is maintained. Even if the first potential becomes lower than the intermediate potential, the sense amplifier can correctly identify the data stored in the selected access unit as the data “H”, as long as the first potential is higher than the second potential. Thus, the data retention characteristic is improved as compared with the usual DRAM.

As thus described, the display driver IC according to the one embodiment of the present invention is provided with the embedded DRAM that has the extremely excellent data retention characteristic. Therefore, the embedded DRAM can operate normally, even if the IC chip is stressed during the heat treatment and the like in the packaging process or the mounting process and thereby the data retention characteristic is varied to a certain degree. Since the malfunction of end products is prevented, the yield is improved.

Although a chip area of a display driver IC can be reduced in the case where an embedded SRAM is replaced with an embedded DRAM, an operation speed may be degraded because a random access speed of a usual DRAM is lower than that of the SRAM. According to the one embodiment of the present invention, however, the data read margin is enlarged as described above. This means that a time required for identifying the data is shortened and thus the operation speed is improved as compared with the usual DRAM. It is therefore possible according to the one embodiment not only to reduce the chip area of the display driver IC but also to prevent the degradation of the operation speed.

According to the one embodiment of the present invention, as described above, the display driver IC is provided with the embedded DRAM that has the extremely excellent data retention characteristic. Consequently, the malfunction of end products is prevented and the yield is improved. Moreover, it is possible not only to reduce the chip area of the display driver IC but also to prevent the degradation of the operation speed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic block diagram illustrating a layout of a display driver IC;

FIG. 2 is a block diagram showing a circuit configuration of a display driver IC according to embodiments of the present invention;

FIG. 3 shows a configuration of an embedded DRAM and access methods according to a first embodiment of the present invention;

FIG. 4 is a timing chart showing an example of a data read operation;

FIG. 5 is a timing chart showing another example of a data read operation;

FIG. 6 shows a configuration of an embedded DRAM and an access method according to a second embodiment of the present invention; and

FIG. 7 shows a configuration of a typical open-bit-sense type DRAM.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display apparatus and a display driver IC according to embodiments of the present invention will be described with reference to the accompanying drawings. The display apparatus is exemplified by a liquid crystal display.

### 1. First Embodiment

### 1-1. Overall Configuration

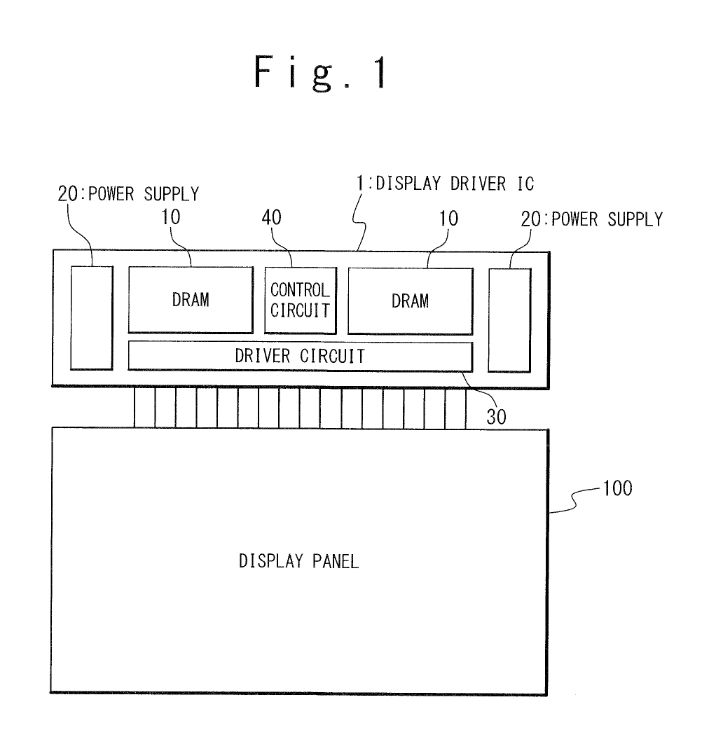

FIG. 1 illustrates a layout of a display driver IC 1 according to the embodiments of the present invention. The display driver IC 1 is an integrated circuit for controlling display of an image on a display panel 100. The display driver IC 1 is provided with an embedded DRAM 10, a power supply circuit 20, a driver circuit 30, a display control circuit 40 and the like. The display driver IC 1 is integrated on a single chip. As shown in FIG. 1, the display driver IC chip is long from side to side, i.e., the display driver IC chip has a “strip shape”. Such a strip shape is peculiar to the display driver IC used in the image display apparatus.

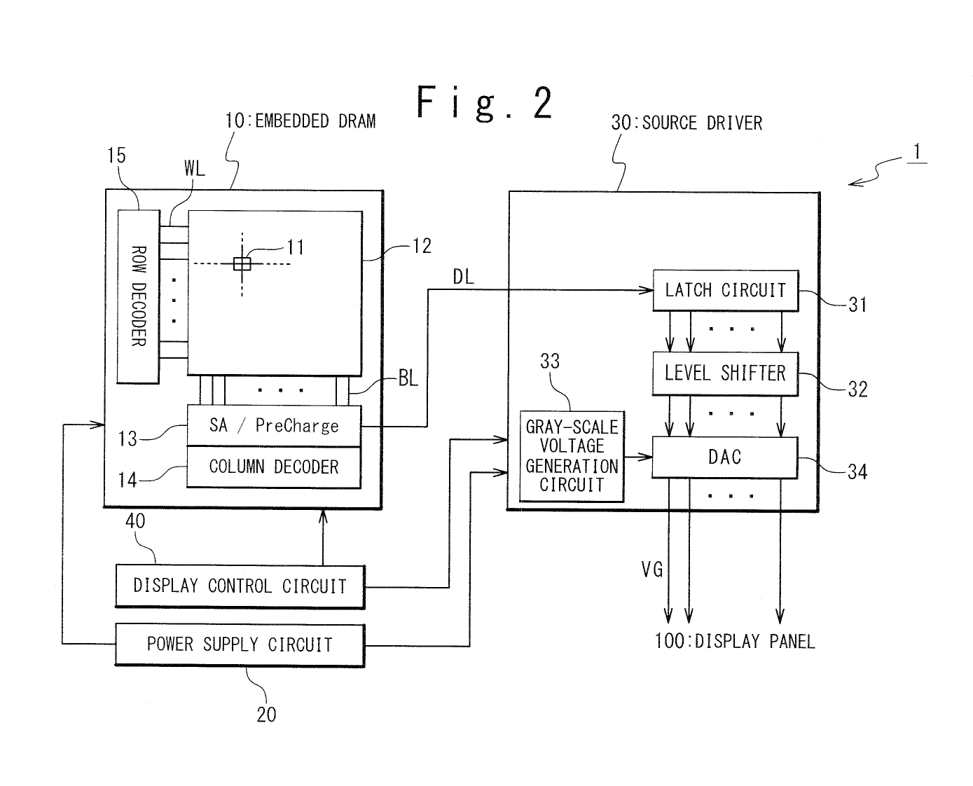

FIG. 2 is a block diagram showing a circuit configuration of the display driver IC 1 according to the present embodiment. In FIG. 2, a source driver 30 connected to source lines of the display panel 100 is illustrated as the above-mentioned driver circuit 30.

The embedded DRAM 10 is used for storing display data that is digital data corresponding to an image to be displayed on the display panel 100. That is to say, the display driver IC 1 has the embedded DRAM 10 (DRAM macro) instead of an embedded SRAM as an embedded memory for use in storing the display data. The embedded DRAM 10 includes a memory cell array 12, a sense amplifier circuit 13, a column decoder 14 and a row decoder 15. The memory cell array 12 includes a plurality of memory cells 11 that are arranged in an array form. A plurality of word lines WL and a plurality of bit lines BL are so formed as to intersect with each other, and the memory cells 11 are arranged at respective intersection points. The row decoder 15 is connected to the plurality of word lines WL, and selects designated ones among the plurality of word lines WL. The column decoder 14 is connected to the plurality of bit lines BL through the sense amplifier circuit 13, and selects designated ones among the plurality of bit lines BL. The sense amplifier circuit 13 senses and outputs cell data that is stored in the memory cells 11, on the basis of potentials of the bit lines BL. Also, the sense amplifier circuit 13 includes a pre-charge circuit for pre-charging the bit lines BL to a predetermined potential.

The power supply circuit 20 supplies electric power to each circuit.

The source driver 30 receives a display data DL for one line from the embedded DRAM 10. Then, the source driver 30 converts the display data DL into corresponding gray-scale voltages (analog output voltages), and outputs the gray-scale voltages as pixel voltages VG to the display panel 100. More specifically, the source driver 30 includes a latch circuit 31, a level shifter 32, a gray-scale voltage generation circuit 33 and a DA converter 34. The latch circuit 31 latches the display data DL for one line. The display data DL is supplied to the DA converter 34 through the level shifter 32. Meanwhile, the gray-scale voltage generation circuit 33 generates a plurality kinds of gray-scale voltages and outputs the plurality kinds of gray-scale voltages to the DA converter 34. Based on the plurality kinds of gray-scale voltages, the DA converter 34 outputs the gray-scale voltages corresponding to the received display data DL. The output gray-scale voltages are applied as the pixel voltages VG to pixels of the display panel 100.

The display control circuit 40 controls operations of each circuit.

### 1-2. Embedded DRAM 10

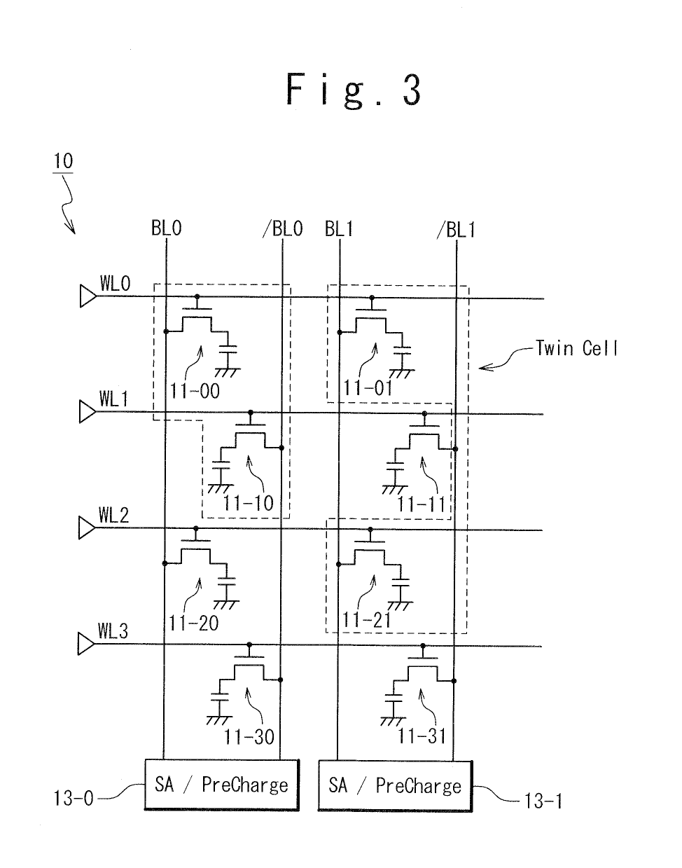

Next, operations of the embedded DRAM 10 according to the present embodiment will be described in more detail. FIG. 3 is a circuit diagram partially illustrating a configuration of the memory cell array 12 of the embedded DRAM 10. Word lines WL0 to WL3 and bit lines BL0,/BL0, BL1 and/BL1 are so arranged as to intersect with each other, and memory cells 11-00 to 11-31 are arranged at the respective intersections. Each memory cell 11 is provided with an MOS transistor and a cell capacitor. The gate of the MOS transistor of each memory cell 11 is connected to an associated one of the word lines WL. One of the source and drain of the MOS transistor is connected to an associated one of the bit lines BL, and the other is connected to the cell capacitor. The bit lines BL0 and/BL0, which are connected to the same sense amplifier circuit 13-0, constitute a pair of complementary bit lines. Similarly, the bit lines BL1 and/BL1, which are connected to the same sense amplifier circuit 13-1, constitute a pair of complementary bit lines.

The DRAM structure described above is the same as that of a typical DRAM and can be manufactured through general processes. It should be noted in the present embodiment that the embedded DRAM 10 stores one bit data by using n memory cells (n is an integer of 2 or more). In other words, a set of n memory cells 11 is regarded as “one access unit” at the time of data reading and writing. The set of n memory cells 11 as the access unit at the data reading/writing may be hereinafter referred to as a “unit memory cells”.

For example, two memory cells 11-00 and 11-10 shown in FIG. 3 are regarded as one access unit (unit memory cells). The two memory cells 11-00 and 11-10 are respectively connected to the different word lines WL0 and WL1. Also, the two memory cells 11-00 and 11-10 are respectively connected to the complementary bit lines BL0 and/BL0, which are connected to the same sense amplifier circuit 13-0.

Let us consider a case as an example where the data “H” is written into the access unit including the two memory cells 11-00 and 11-10 (Twin Cell). At the time of data write operation, the DRAM 10 simultaneously selects the two word lines WL0 and WL1 which are respectively connected to the memory cells 11-00 and 11-10 belonging to the access unit. Such selection may be referred to as “multiple selection”, hereinafter. After the multiple selection, the data “H” is written into the one memory cell 11-00 through the bit line BL0, while the complementary data “L” is written into the other memory cell 11-10 through the bit line/BL0. It should be noted here that the bit lines BL0 and/BL0 form the pair of complementary bit lines, and the word lines WL0 and WL1 are selected at the same time.

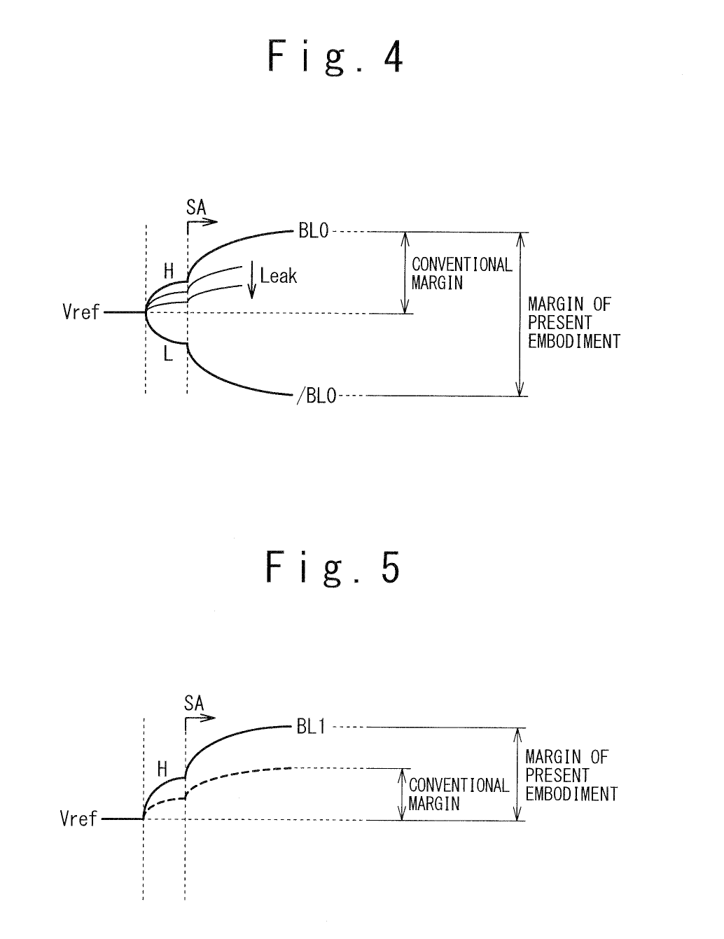

The read operation of the data stored in the access unit composed of the two memory cells 11-00 and 11-10 is as follows. Referring to FIG. 3 and FIG. 4, the bit lines BL0 and/BL0 are first pre-charged to a reference potential Vref by a pre-charge circuit within the sense amplifier circuit 13-0. The reference potential Vref is typically an intermediate potential (VDD/2) between a power supply potential VDD and a ground potential GND. After that, the DRAM 10 makes the multiple selection of the two word lines WL0 and WL1 again. As a result, a first potential (the higher potential) corresponding to the data “H” appears on the bit line BL0, while a second potential (the lower potential) corresponding to the data “L” appears on the bit line/BL0. The sense amplifier circuit 13-0 amplifies a difference between the first potential and the second potential and thereby identifies the data stored in the access unit as the data “H”. In FIG. 4, the difference between the first potential on the bit line BL0 and the second potential on the bit line/BL0 is indicated by “margin of present embodiment”.

By way of comparison, let us consider a case where only one word line is selected as in the usual DRAM. The bit lines BL0 and/BL0 are first pre-charged to the reference potential Vref by the pre-charge circuit within the sense amplifier circuit 13-0. When the memory cell 11-00 into which the data “H” is written is selected, the first potential corresponding to the data “H” appears on the bit line BL0. The sense amplifier circuit 13-0 senses the data stored in the selected memory cell 11-00, on the basis of a difference between the first potential on the bit line BL0 and the reference potential Vref on the bit line/BL0. In FIG. 4, the difference between the first potential and the reference potential Vref is indicated by “conventional margin”. One issue here is that the first potential is decreased as electric charges are leaked from the cell capacitor of the memory cell 11-00, which degrades the sensing performance of the sense amplifier circuit. In the worst case, the first potential becomes lower than the reference potential Vref and thus the sense amplifier circuit 13-0 erroneously identifies the data stored in the selected memory cell 11-00 as the opposite data “L”.

According to the present embodiment, on the other hand, the data stored in the selected access unit is identified on the basis of the difference between the first potential corresponding to the data “H”, which is originally higher than the reference potential Vref, and the second potential corresponding to the data “L”, which is lower than the reference potential Vref, as describe above. In other words, the data read margin is enlarged as compared with the usual DRAM. Although the first potential may be decreased due to the leakage of electric charges from the cell capacitor of the memory cell 11-00, the difference between the first potential and the second potential is still sufficient, which improves the sensing performance of the sense amplifier circuit 13-0. Even if the first potential becomes lower than the reference potential Vref, the sense amplifier circuit 13-0 can correctly identify the data stored in the selected access unit as the data “H”, as long as the first potential is higher than the second potential. Consequently, the possibility of erroneous data reading is greatly reduced and the data retention characteristic (data destruction resistance) is improved, as compared with the usual DRAM. No special memory cell structure is necessary.

It should be noted that no electric charge could be leaked from the cell capacitor of a memory cell storing the data “L”, although electric charges may be leaked from the cell capacitor of a memory cell storing the data “H”. In this sense, the data retention characteristic (data destruction resistance) of the memory cell storing the data “L” is excellent. The second potential that appears on a bit line associated with the data “L” is definitely lower than the reference potential Vref. It can be said in the example shown in FIG. 4 that the sensing performance is improved by using the second potential lower than the reference potential Vref instead of using the reference potential Vref.

The access unit is not limited to two memory cells respectively connected to complementary bit lines. The access unit (unit memory cells) can be comprised of two memory cells connected to the same bit line. Referring back to FIG. 3, for example, the two memory cells 11-01 and 11-21 which are connected to the same bit line BL1 may be regarded as one access unit. When the data “H” is written into the access unit composed of the memory cells 11-01 and 11-21 (Twin Cell), the DRAM 10 makes a multiple selection of the two word lines WL0 and WL2 connected to the access unit. As a result, the data “H” is written into both of the memory cells 11-01 and 11-21.

The data read operation from the access unit composed of the memory cells 11-01 and 11-21 is as follows. Referring to FIG. 3 and FIG. 5, the bit lines BL1 and/BL1 are first pre-charged to the reference potential Vref by a pre-charge circuit within the sense amplifier circuit 13-1. After that, the DRAM 10 makes the multiple selection of the two word lines WL0 and WL2 again. As a result, a potential corresponding to the data “H” appears on the bit line BL1. The sense amplifier circuit 13-1 amplifies a difference between the potential appearing on the bit line BL1 and the reference potential Vref appearing on the bit line/BL1, and thereby identifies the data stored in the access unit as the data “H”. In this case, the potential appearing on the bit line BL1 is a sum of a potential associated with the memory cell 11-01 and a potential associated with the memory cell 11-21, which is increased as compared with a usual case where only one memory cell is selected. In other words, as shown in FIG. 5, the “margin of present embodiment” is enlarged as compared with the “conventional margin”. Consequently, the possibility of erroneous data reading is reduced, even when electric charges are leaked from the cell capacitor.

Although a set of two memory cells 11 (Twin Cell) is regarded as an access unit in the above-described examples, a set of three or more memory cells 11 may be regarded as one access unit. In this case, the three or more memory cells 11 belonging to the same access unit are connected to a pair of complementary bit lines connected to the same sense amplifier circuit 13. In data writing and data reading, multiple word lines WL connected to the access unit are simultaneously selected. In this case, a combination of the effect shown in FIG. 4 and the effect shown in FIG. 5 can be obtained, which further improves the data retention characteristic. It should be noted, however, that one access unit is preferably composed of two memory cells (n=2), from the viewpoint of the number of access units per unit area.

### 1-3. Effect

As thus described, the display driver IC 1 according to the present embodiment is provided with the embedded DRAM 10 that has the extremely excellent data retention characteristic. Therefore, the embedded DRAM 10 can operate normally, even if the IC chip is stressed during the heat treatment and the like in the packaging process or the mounting process and thereby the data retention characteristic is varied to a certain degree. Since the malfunction of end products is prevented, the yield is improved. This can be said to be an effect peculiar to the display driver IC 1 having the strip shape.

Although a chip area of a display driver IC can be reduced in the case where an embedded SRAM is replaced with an embedded DRAM, an operation speed may be degraded because a random access speed of a usual DRAM is lower than that of the SRAM. According to the present embodiment, however, the data read margin is enlarged and the sensing performance is improved, as described above. This means that a time required for identifying the data is shortened and thus the operation speed is improved as compared with the usual DRAM. It is therefore possible according to the present embodiment not only to reduce the chip area of the display driver IC 1 but also to prevent the degradation of the operation speed.

### 2. Second Embodiment

As described above, the chip area of the display driver IC can be reduced by replacing an embedded SRAM with an embedded DRAM. However, in the case where the access unit of the data reading/writing is the twin cell, a memory cell array area required for the same storage capacity doubles as compared with a case where the access unit is a single cell, which weakens the chip area reduction effect. It is therefore preferable to make an area of one DRAM cell as small as possible. The layout structure of the memory cells 11 shown in the foregoing FIG. 3 is the so-called “8F² cell” structure. In a second embodiment of the present invention, a “6F² cell” structure is employed instead of the “8F² cell” structure.

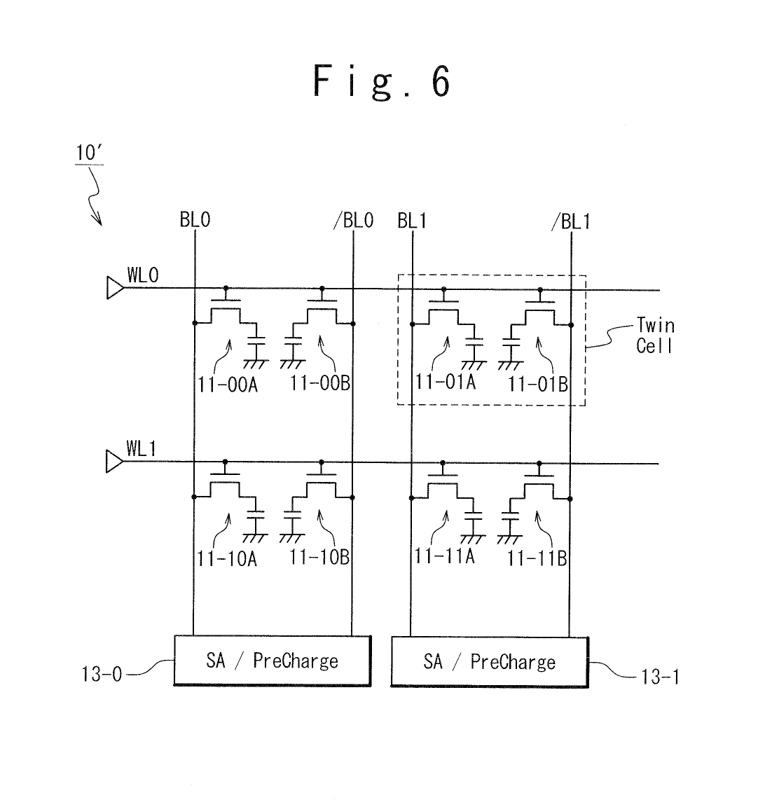

FIG. 6 is a circuit diagram showing a part of a memory cell array 12 of an embedded DRAM 10′ according to the second embodiment. Memory cells 11-00A to 11-01B are connected to a word line WL0, while memory cells 11-10A to 11-11B are connected to a word line WL1. The memory cells 11-00A and 11-10A are connected to a bit line BL0, and the memory cells 11-00B and 11-10B are connected to a bit line/BL0. The bit lines BL0 and/BL0 form a pair of complementary bit lines that are connected to the same sense amplifier circuit 13-0. Memory cells 11-01A and 11-11A are connected to a bit line BL1, and memory cells 11-01B and 11-11B are connected to a bit line/BL1. The bit lines BL1 and/BL1 form a pair of complementary bit lines that are connected to the same sense amplifier circuit 13-1. Each of the memory cells 11 is a “6F² cell”.

As in the first embodiment, the DRAM 10′ stores one bit data by using n memory cells 11 (n is an integer of 2 or more) as an access unit. For example, the two memory cells 11-01A and 11-01B shown in FIG. 6 are regarded as one access unit (unit memory cells). The two memory cells 11-01A and 11-01B are connected to the same word line WL0. Also, the two memory cells 11-01A and 11-01B are respectively connected to the complementary bit lines BL1 and/BL1 which are connected to the same sense simplifier circuit 13-1. In the data writing and data reading, the DRAM 10′ selects only the one word line WL0 connected to the access unit.

Consequently, the same effects as in the first embodiment can be obtained. Moreover, the chip area reduction effect becomes much more remarkable, because the 6F² cell structure is employed. Furthermore, since the multiple selection of the word lines is unnecessary, it is possible to reduce the size of the row decoder 15.

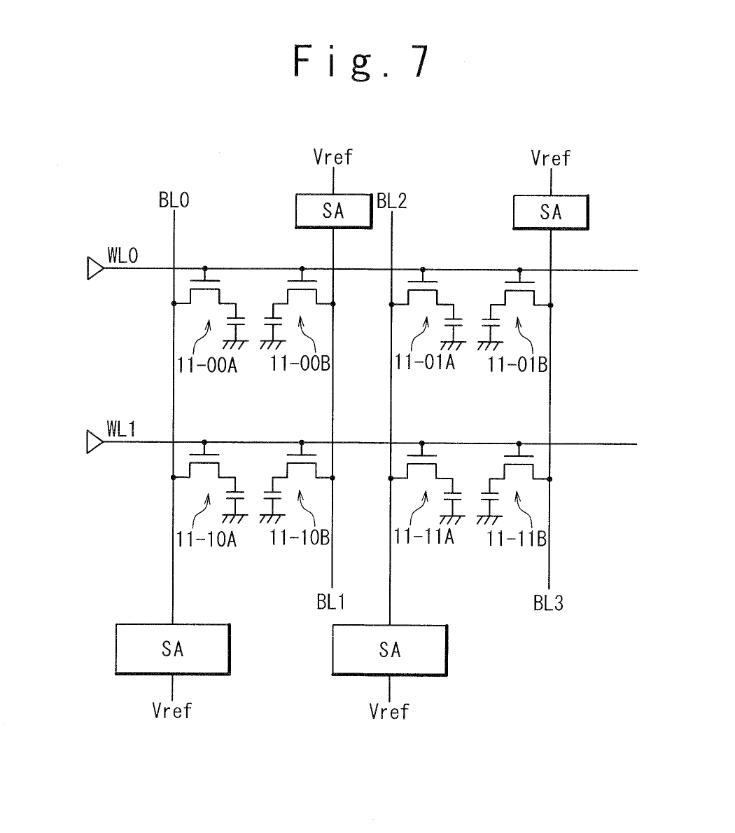

Note that FIG. 7 shows a usual DRAM configuration when the 6F² cell is employed. As to the usual DRAM shown in FIG. 7, it is necessary to perform the data writing/reading with respect to one memory cell 11 (for example, the memory cell 11-01A in FIG. 7). In this case, it is necessary to employ an open-bit-sense type sense amplifier so as to prevent the data writing/reading with respect to the adjacent memory cell 11-01B. That is to say, it is necessary to provide the open-bit-sense type sense amplifiers for the bit lines BL0 to BL3, respectively. In this case, the number of sense amplifiers is increased and thus the sense amplifier area is increased.

As can be seen from a comparison between FIG. 6 and FIG. 7, the number of sense amplifiers is smaller in the case of FIG. 6. According to the present embodiment, it is possible to employ the sense amplifier circuit 13 of “complementary-bit-type” which is connected to a pair of complementary bit lines, even in the case of the 6F² cell structure. This is because the data writing/reading is performed with respect to the twin cell (for example, the memory cells 11-01A and 11-01B) connected to the pair of complementary bit lines. In this manner, it is possible according to the present embodiment to employ both of the “6F² cell” and the “complementary-bit-type” at the same time. It is thus possible to reduce the chip area without increasing the sense amplifier area. This is a synergy effect that can be especially obtained in the case where multiple memory cells 11 are treated as the access unit as in the present embodiment.

It is apparent that the present invention is not limited to the above embodiments and may be modified and changed without departing from the scope and spirit of the invention.

What is claimed is:

1. A display driver IC for controlling display of an image on a display panel, comprising:
a DRAM having a plurality of memory cells and configured to store digital data corresponding to said image; and
a driver circuit configured to convert said digital data into a gray-scale voltage and to output said gray-scale voltage to said display panel,
wherein said DRAM stores one bit data by using n memory cells of said plurality of memory cells, n being an integer of 2 or more.

2. The display driver IC according to claim 1,
wherein said n is two.

3. The display driver IC according to claim 2,
wherein said two memory cells are connected to a pair of complementary bit lines, respectively, said complementary bit lines being connected to a same sense amplifier.

4. The display driver IC according to claim 2,
wherein said two memory cells are connected to a same bit line.

5. The display driver IC according to claim 1,
wherein in data writing and data reading, said DRAM simultaneously selects n word lines that are respectively connected to said n memory cells.

6. The display driver IC according to claim 3,
wherein said two memory cells are connected to a same word line.

7. The display driver IC according to claim 6,
wherein each of said two memory cells is a 6F² cell.

8. The display driver IC according to claim 6,
wherein in data writing and data reading, said DRAM selects only said same word line.
